(19) United States
(12) Patent Application Publication
(10) Pub. No.: US 2005/0034549 A1
(43) Pub. Date: Feb. 17, 2005

(54) Device for interactive control with the hand of an operator

(75) Inventor: Marcel-Claude Braud, Ancenis (FR)

Correspondence Address: YOUNG & THOMPSON, 745 SOUTH 23RD STREET, 2ND FLOOR, ARLINGTON, VA, 22202, US

(73) Assignee: MANITOU BF, ANCENIS (FR)

(21) Appl. No.: 10/914,228

(22) Filed: Aug. 10, 2004

(30) Foreign Application Priority Data
Aug. 11, 2003 (FR) 03 09814

(51) Int. Cl. G05G 1/10

(52) U.S. Cl. 74/473.1; 74/543

(57) ABSTRACT

The device for interactive control with the hand of an operator, particularly of an operator of machinery or material or an engine with multiple functions, comprises a configuration for interaction with the palm of the hand, so as to avoid the gripping of the fingers of the operator on the device, thus permitting an interaction of the palm and fingers of the operator with the device for the accomplishment of multiple functions.

The invention relates to a device for interactive control with the hand of an operator, particularly a machine or material operator or the driver of an engine with multiple functions.

EP 1 283 535 A2 discloses a manual control for a remotely controlled vehicle. This manual control for a remotely controlled submarine vehicle has left, right and vertical buttons. The manual control can be grasped between the fingers and the palm of a hand. An orientable lever is mounted to be actuated by the thumb, and is configured to provide control signals for the left and right push members of the remotely controlled vehicle. A button with two positions is mounted to be controlled by the index finger. The two positions provide respective control signals to cause the remotely controlled vehicle to rise or descend.

The manual control of EP 1 283 535 A2 however has the drawback according to which the force of grasping and gripping gives rise to fatigue and twitching of the hand which must keep gripping the apparatus.

The known manual control handles generally have the drawback of requiring gripping or interactive grasping of the control stick or the body of the control handle to permit effective actuation by the operator.

Thus, the existing assembly of control handles, usable particularly to drive work yard machines, agricultural machines, trucks with telescopic arms, have the principal drawback of causing excessive fatigue in the hand inevitably resulting in twitching of the fingers of the operator on the control stick.

The first object of the invention is to overcome the drawbacks of the known technique, by providing a new device avoiding twitching of the fingers of the operator.

DE 94 17 838 discloses a manually actuated control device, with multiple control channels, comprising a configuration that can be gripped from above and suitable for all the hand, and having a switching button arranged and shaped to be able to be actuated by the thumb, when the hand holds or rests on said configuration.

The device of DE 94 17 838 is generally satisfactory, but does not permit rapid interaction with the fingers of an operator driving a machine, a device or engine operating continuously or at high speeds of actuation.

A second object of the invention is to provide an ergonomic device permitting rapid freeing of the fingers, so as to rapidly to trigger the multiple functions by the action of several fingers on the hand.

A third object of the invention is to provide a new device permitting natural interaction of the hand of the operator to accomplish multiple functions.

The invention has for its object a control device that is interactive with the hand of an operator, particularly a machine or material operator or the driver of a multiple function engine, comprising a configuration that is interactive with the palm of the hand, so as to avoid gripping the fingers of the operator on the device, whilst permitting interaction of the palm and the fingers of the operator with the device to accomplish multiple functions, characterized by the fact that the interactive configuration has actuating means oriented substantially in the direction of the thumb and index finger of the operator, so as to avoid any lateral force on the thumb or index finger and so as to avoid any movement of the palm of the hand during actuation.

According to other characteristics of the invention:
the interactive configuration with the palm of the hand is at least locally substantially in the form of a saddle;
the interactive configuration with the palm of the hand is substantially in the shape of a hyperbolic paraboloid;
the interactive configuration with the palm of the hand has a surface with an interaction zone with the thumb of the hand of the operator;
the interactive configuration with the palm of the hand is prolonged forwardly by a zone of interaction with the index finger of the hand of the operator;
the configuration of interaction with the palm of the hand is connected downwardly to a zone of interaction with the middle finger of the hand of the operator;
at least one zone of interaction with the finger of the hand of the operator is provided with at least one member controllable by this finger;
the member controllable by a finger of the hand of the operator is selected from the following list: pushbuttons, buttons with several positions, adjustment wheels, proportional wheels, switches, or like members;
the configuration of interaction with the palm of the hand is arranged to swing the device in a direction selected by the operator to achieve a single or combined action desired by the operator;
the device is mounted swingably in several directions corresponding to a function or to a combination of simultaneous functions.

The invention will be better understood from the description which follows, given by way of non-limiting example with reference to the accompanying drawings, in which:

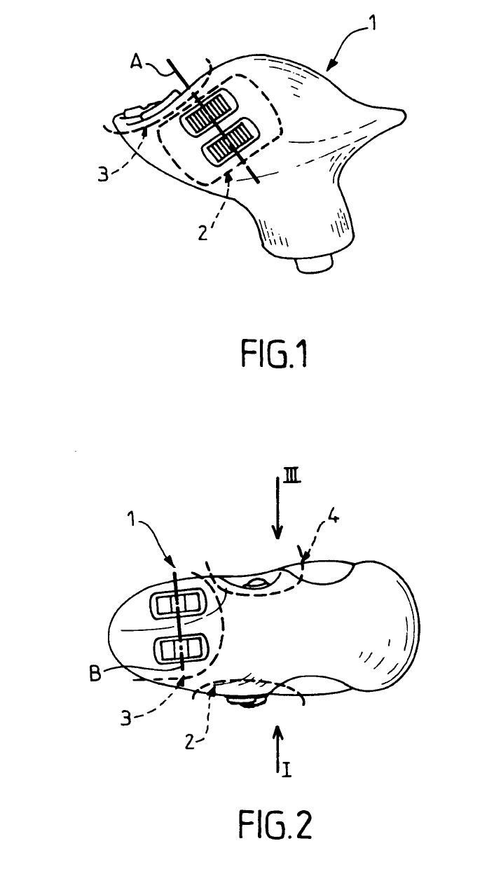

FIG. 1 is a schematic side elevational view in the direction of the arrow I of FIG. 2, of a control device according to the invention.

FIG. 2 is a schematic plan view of a control device according to the invention.

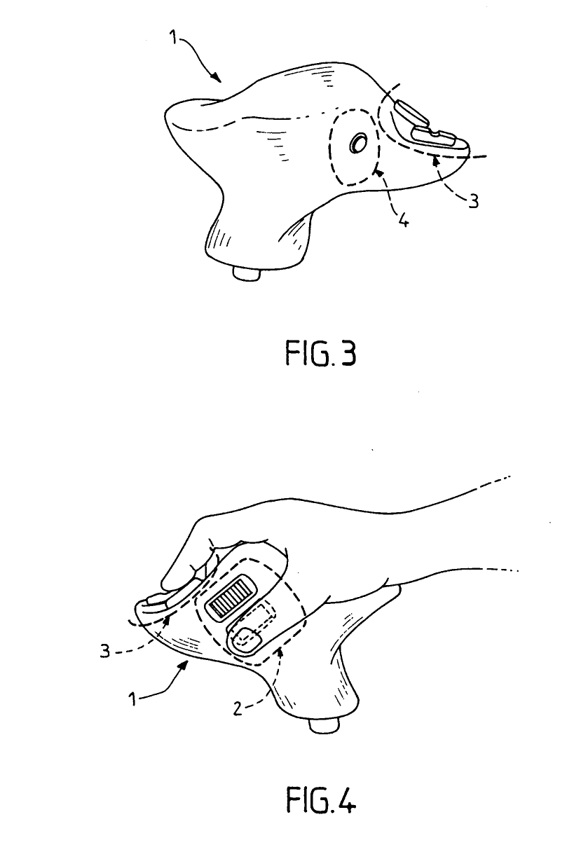

FIG. 3 is a schematic side elevational view in the direction III of FIG. 2, of a control device according to the invention.

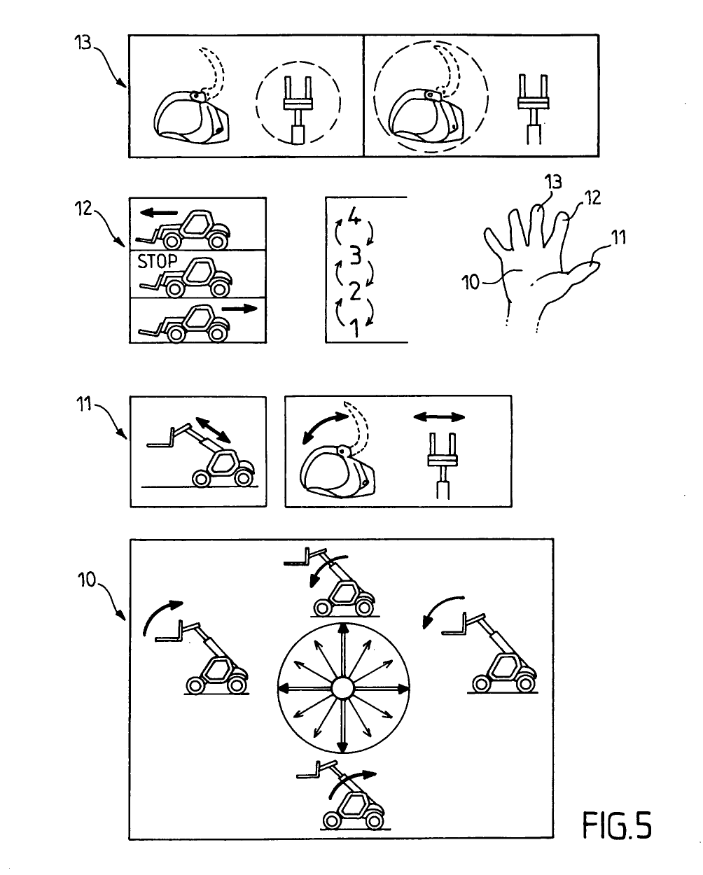

FIG. 4 is a schematic perspective view showing the interaction of the hand of the operator with a control device according to the invention.

FIG. 5 is a schematic view of a table explaining multiple functions that can be carried out with the help of a control device according to the invention.

Referring to FIGS. 1 to 4, identical or functionally equivalent elements are represented by identical reference numerals.

In FIG. 1, the control device according to the invention has an upper configuration substantially in the form of an inclined horse's saddle or substantially in the shape of a hyperbolic paraboloid. This upper configuration permits the freely bearing on the palm of the hand, to actuate the assembly of the device according to a multitude of radial directions.

On the surface 1 of the arrangement is provided a zone 2, delimited in broken lines, of interaction with the thumb of the hand of the operator.

The zone 2 thus permits particularly the mounting of actuating buttons for several positions, of adjustment wheels with automatic return, of proportional adjustment wheels, of switches with multiple positions or any other member that can be controlled by the thumb, for example linear movement members of the cursor type, with automatic return or not.

The implementation of the actuating means in the zone 2 is carried out angularly, so as to permit an actuation by the thumb with the help of a bending/extension movement, without lateral force on the thumb and without movement of the palm of the hand.

In the case of actuating means swinging to several positions, the substantially angular orientation of these swinging means permits providing one or several axes A of pivoting or swinging oriented substantially transversely to the direction of the thumb in the course of actuation.

In FIG. 2, the front of the configuration of the device according to the invention has an incurved region 3 delimited in broken lines, for interaction with the index finger of the operator, when the palm of the hand rests on the upper configuration of the device, substantially in the form of an inclined horse's saddle or substantially in the form of a hyperbolic paraboloid.

Because the thumb and index finger of the operator are entirely extended and available to actuate control members, no fatigue of twitching or gripping hinders or reduces the actions of the operator.

The zone 3 delimited in broken lines also permits the mounting of all types of members that can be controlled or actuated by an index finger: the zone 3 thus permits notably the mounting of actuating buttons for several positions, of adjustment wheels with automatic return, of proportional adjustment wheels, of multiple position switches or any other member that can be controlled by an index finger.

The implantation of actuating means in the zone 3 is carried out substantially longitudinally, so as to permit actuation by the index finger with the help of a bending/extension movement, without lateral force on the index finger and without movement of the palm of the hand.

In the case of actuating means that swing to several positions, the substantially longitudinal orientation of implantation of the swinging means permits providing one or several axes B of pivoting or swinging oriented substantially transversely to the longitudinal direction of the device and to the direction of the index finger in the course of actuation.

In FIG. 3, the device according to the invention presents from below the rest position of the palm of the hand, a hollow region 4 delimited in broken lines, of interaction with the middle finger of the hand of the operator.

The zone 4 delimited in broken lines permits the mounting of all types of members that can be controlled by a middle finger: the zone 4 thus permits particularly the mounting of actuating buttons with several positions, of adjustment wheels with automatic return, of proportional adjustment wheels, of switches with multiple positions or of any other member that can be controlled by a middle finger.

Because of the free pressure and of the resting of the palm of the hand on the upper portion substantially in the form of a horse's saddle, the middle finger of the hand of the operator is also extended and is not subject to any twitching from gripping.

The principle of delimitation of preferred interaction zones with a predetermined finger of the hand of an operator, can also be extended without departing from the scope of the present invention to other fingers of the operator. Thus, it is possible to design devices according to the invention adapted particularly to particular hands, for example to a hand of the operator whose middle finger would have been amputated or partially impaired. It is also possible, without departing from the scope of the present invention, to design devices according to the invention adapted to the left hand of a left-handed operator, or either usable without preference by a left hand or a right hand by means of a new arrangement or a reprogramming of the corresponding functions.

However, the usual preferred manner of arranging the device according to the invention is the embodiment providing for the interaction of the palm of the hand with the device, and of two or three fingers of the hand of the operator with the device, these two or three fingers being selected usually from the group comprising the thumb, the index finger and the middle finger.

In FIG. 4, the hand of an operator is shown in the position overlapping the configuration like a horse's saddle of a device according to the invention.

The natural position of the thumb, of the index finger and of the middle finger permit the hollow of the palm to bear against the upper configuration and to ensure an ergonomic equilibrium of the hand of the operator on the device according to the invention.

The device according to the invention can be used in an autonomous manner, because no twitching or fatigue from gripping the fingers is generally to be feared. However, in the case of machines that move or vibrate, for example in the case of trucks with a telescopic arm, there should be provided a second bearing place for the forearm of the operator, so as to avoid the transmission of vibrations of the moving machines to the forearm muscles and to the hand.

This is why there is generally provided, in combination with the device according to the invention, an armrest permitting resting the forearm of the operator and filtering out parasitic vibrations adapted to be transmitted to the forearm.

In FIG. 5, the illustrated table indicates by lines the functions adapted to be achieved by a portion of the hand of an operator, for example of the driver of a truck with a telescoping arm.

The first line 10 indicates the functions accomplished by interaction of the palm of the operator with the device according to the invention.

When the machine operates in a handling mode, the palm of the hand permits swinging the device according to the invention in an infinity of directions having four principal axes: the swinging of the device forwardly corresponds to the descent of the telescopic arm, the swinging of the device toward the rear corresponds to raising the telescopic arm, the swinging of the device to the left corresponds to digging, the swinging of the device to the right corresponds to emptying, the swinging of the device in any direction corresponds to a combined action proportional to the orientation of the device relative to the principal axes.

The second line 11 indicates the functions accomplished by interaction of the thumb of the operator with the device according to the invention.

The movement of extension or retraction of the telescope can in all cases be controlled to a desired extension or retraction speed by the thumb with the help of a proportional wheel with automatic return upon release.

Another button, wheel or optional member can be provided, either for controlling a desired speed by the thumb of a first function of a work accessory disposed at the arrowhead and adapted to complete the action of a working member carried by the telescopic arm, or for the control of a second supplemental accessory function disposed at the head of the arrow, proportionally, with automatic return upon release. This other button can lock the working accessory on the apron or control the hydraulic flow of the corresponding accessory jack with the help of a proportional electrical control.

The third line 12 indicates the functions achieved by interaction of the index finger of the operator with the device according to the invention.

The functions of mobility of the machine are actuated when the index finger of the operator acts on a reversing button with three stable positions to cause the machine to move forward, to stop in neutral position, or to move rearwardly.

The control of raising and lowering the speeds of the gear change can be carried out in a staged manner with the help of another pushbutton or another control member actuated by the index finger, as indicated by line 12. This stage control for changing speeds of the gear change can be carried out as well during increase and decrease of the speed, and preferably under a load.

The fourth line 13 indicates the functions achieved by interaction of the middle finger of the operator with the device according to the invention.

An optional control button actuable by the middle finger permits ensuring a distribution as desired of the hydraulic flow rates between one and the other of the accessory jacks disposed at the arrowhead, so as to actuate the first accessory working function disposed at the arrowhead actuable by the thumb, and indicated in line 11, or to actuate the second function of the supplemental accessory disposed at the arrowhead, actuable by the thumb, and indicated on line 11.

The distributions of the flow rate and functions of power or auxiliary functions can be modified simultaneously by combinations of the functions of the buttons or members actuated by the palm or by the fingers of the operator.

Preferably, the device according to the invention can be combined with a dashboard showing the operation in real time of the machine and sending visual, vocal or acoustical messages warning the operator of critical positions or situations, for example in the case of the limit of stability of the machine.

Also, the operation of the device according to the invention can be limited by material abutments or software controls guaranteeing continuously a safe function of a machine controlled by the device according to the invention.

Thus, thanks to the invention, the following functions can be actuated simultaneously with swinging of the device by the action of the palm:
extension and retraction of the telescope by the action of the thumb, and mobility of the machine by action of the index finger;
extension or retraction of the telescope by action of the thumb, and change of speed of advance by the action of the index finger;
opening or closing the first accessory by the action of the thumb, and movement of the machine by action of the index finger;
opening or closing the first accessory by action of the thumb, and changing the speed of advance by the action of the index finger;
selection of the second accessory by the middle finger, and opening or closing this second accessory by the action of the thumb, and movement of the machine by the action of the index finger;
selection of the second accessory by the middle finger, and opening or closing this second accessory by the action of the thumb, and changing the speed of advance by the action of the index finger.

The invention described with reference to several particular embodiments is not thereby limited, but on the contrary covers any modification of shape and all modification of embodiment within the scope and spirit of the invention, the essential thing being to free the fingers of the hand of the operator to permit effective interaction and without twitching or fatigue of gripping the fingers of the operator with the device according to the invention.

1. Control device that is interactive with the hand of an operator, particularly a machine or material operator or an engine with multiple functions, comprising a configuration interactive with the palm of the hand, so as to avoid gripping the fingers of the operator on the device, whilst permitting actuation of the palm and the fingers of the operator with the device to accomplish multiple functions, characterized by the fact that the configuration of interaction has actuating means oriented substantially in the direction of the thumb and the index finger of the operator, so as to avoid any movement of the thumb of the hand during an actuation.

2. Device according to claim 1, characterized by the fact that the configuration of interaction with the palm of the hand is at least locally substantially in the form of a saddle.

3. Device according to claim 1, characterized by the fact that the configuration of interaction with the palm of the hand is substantially in the form of a hyperbolic paraboloid.

4. Device according to claim 1, characterized by the fact that the configuration of interaction with the palm of the hand has a surface (1) with a zone (2) of interaction with the thumb of the hand of the operator.

5. Device according to claim 1 characterized by the fact that the configuration of interaction with the palm of the hand is prolonged forwardly by a zone (3) of interaction with the index finger of the hand of the operator.

6. Device according to claim 1, characterized by the fact that the configuration of interaction with the palm of the hand is connected downwardly to a zone (4) of interaction with the middle finger of the hand of the operator.

7. Device according to claim 4, characterized by the fact that at least one zone (2 or 3 or 4) of interaction with a finger of the hand of the operator is provided with at least one member controllable by this finger.

8. Device according to claim 7, characterized by the fact that the member controllable by a finger of the hand of the operator is selected from the following list: actuating buttons, several position buttons, adjusting wheels, proportional wheels, switches, or like members.

9. Device according to claim 1, characterized by the fact that the configuration of interaction with the palm of the hand is arranged to swing the device in a direction selected by the operator to achieve a single or combined action desired by the operator.

10. Device according to claim 9, characterized by the fact that the device is mounted swingably in several directions corresponding to a function or to a combination of simultaneous functions.

11. Device according to claim 2, characterized by the fact that the configuration of interaction with the palm of the hand is substantially in the form of a hyperbolic paraboloid.

12. Device according to claim 5, characterized by the fact that at least one zone (2 or 3 or 4) of interaction with a finger of the hand of the operator is provided with at least one member controllable by this finger.

13. Device according to claim 6, characterized by the fact that at least one zone (2 or 3 or 4) of interaction with a finger of the hand of the operator is provided with at least one member controllable by this finger.
